(19) United States
(12) Patent Application Publication
(10) Pub. No.: US 2010/0213904 A1
(43) Pub. Date: Aug. 26, 2010

(54) VEHICLE AND DISCHARGE METHOD OF SMOOTHING CAPACITOR IN VEHICLE

(75) Inventor: Kenji Yamada, Komaki-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/711,330

(22) Filed: Feb. 24, 2010

(30) Foreign Application Priority Data
Feb. 24, 2009 (JP) JP2009-041191

(51) Int. Cl. H02J 7/00; H02P 27/00; H02H 11/00

(52) U.S. Cl. 320/166; 318/400.3; 307/326

(57) ABSTRACT

At the time of an occurrence of failures of an inverter, both of two switching elements of the buck-boost converter are switched on so that electric charge is discharged from the smoothing capacitor that smoothes voltage between terminals of the inverter regardless of whether a collision of a vehicle occurs or not (S110, S120). Thus, the electric charge can be securely discharged from the smoothing capacitor at the time of an occurrence of the collision of the vehicle even when at least one of a motor and the inverter is damaged. Also, the electric charge can be securely discharged from the smoothing capacitor at the time of the occurrence of the failures of the inverter.

This application claims priority of Japanese Patent Application No. 2009-41191 filed on Feb. 24, 2009, which is incorporated herein by reference.

### BACKGROUND OF THE INVENTION

1. Field of the Invention

The present invention relates to a vehicle and a discharge method of a smoothing capacitor in the vehicle, in particular to a vehicle including a synchronous motor generator that inputs and outputs power for driving the vehicle, an inverter that drives the synchronous motor generator, a battery, a buck-boost converter provided between the battery and the inverter, and a smoothing capacitor that smoothes voltage between terminals of the inverter, and a discharge method of the smoothing capacitor in the vehicle.

2. Description of the Related Art

One proposed vehicle includes a motor that inputs and outputs power for driving the vehicle, an inverter that drives the motor, a battery that is connected to the inverter, and a smoothing capacitor that smoothes voltage between terminals of the inverter (see, for example, Japanese Patent Laid-Open No. 2005-94883). At the time of an occurrence of a collision of the vehicle, a switching element of an upper arm side of the inverter is switched off and a switching element of a lower arm side of the inverter is switchingly controlled so that the motor is driven to regenerate electric power. All of the switching elements of the inverter are switched on so that electric charge is discharged from the smoothing capacitor when a predetermined time elapses after an absolute value of current passing through the inverter falls to a predetermined value and below.

One proposed motor drive apparatus also includes a motor that inputs and outputs power, an inverter that drives the motor, a battery that is connected to the inverter, and a smoothing capacitor that smoothes voltage between terminals of the inverter (see, for example, Japanese Patent Laid-Open No. 2008-54420). In the motor drive apparatus, when a short circuit of one phase of the inverter occurs, switching elements forming upper and lower arms of the short-circuited phase are simultaneously switched on so that electric charge is discharged from the smoothing capacitor.

### SUMMARY OF THE INVENTION

In the above vehicle, the electric charge can not be discharged from the smoothing capacitor when the inverter fails at the time of an occurrence of the collision of the vehicle. Further, in the vehicle including the above motor drive apparatus, the electric charge can not be discharged from the smoothing capacitor when an open fault occurs in the inverter.

The present invention has a main object to securely discharge stored electric charge in a smoothing capacitor that smoothes voltage between terminals of the inverter upon an occurrence of a collision of the vehicle and a failure of the inverter.

The present invention accomplishes the demand mentioned above by the following configurations applied to a vehicle and a discharge method of smoothing capacitor in the vehicle.

A first vehicle according to the present invention includes a synchronous motor generator that inputs and outputs power for driving the vehicle, an inverter that drives the synchronous motor generator, a battery, a buck-boost converter provided between the battery and the inverter, a smoothing capacitor that smoothes voltage between terminals of the inverter, a collision detector that detects a collision of the vehicle, and a discharge control module that controls the buck-boost converter so that stored electric charge is discharged from the smoothing capacitor when the collision detector detects the collision of the vehicle.

In the first vehicle according to the present invention, the buck-boost converter is controlled so that stored electric charge is discharged from the smoothing capacitor that smoothes voltage between terminals of the inverter upon a detection of the collision of the vehicle. Thus, the stored electric charge can be securely discharged from the smoothing capacitor even when the synchronous motor generator and/or the inverter fail upon an occurrence of the collision of the vehicle.

In the first vehicle according to the present invention, the buck-boost converter may include a reactor having one connection terminal connected to a positive terminal of the battery, a first switching element that switches between connection and disconnection between the other connection terminal of the reactor and a positive terminal of the inverter, and a second switching element that switches between connection and disconnection between the other connection terminal of the reactor and negative terminals of the battery and the inverter. Further, the discharge control module may perform switching control of the first and second switching elements so that the stored electric charge is discharged from the smoothing capacitor. In this case, the discharge control module may control the first and second switching elements so that a positive terminal and a negative terminal of the smoothing capacitor are short-circuited. Thus, the stored electric charge can be immediately discharged from the smoothing capacitor.

In the first vehicle according to the present invention, the discharge control module may control the inverter so that the stored electric charge is discharged from the smoothing capacitor when the stored electric charge is to be discharged from the smoothing capacitor and the collision detector does not detect the collision of the vehicle. In this case, the vehicle may include a failure detector that detects a failure of the inverter. Further, the discharge control module may control the buck-boost converter so that the stored electric charge is discharged from the smoothing capacitor when the stored electric charge is to be discharged from the smoothing capacitor and the failure detector detects the failure of the inverter even when the collision detector does not detect the collision of the vehicle. Thus, the stored electric charge can be securely discharged from the smoothing capacitor.

A second vehicle according to the present invention includes a synchronous motor generator that inputs and outputs power for driving the vehicle, an inverter that drives the synchronous motor generator, a battery, a buck-boost converter provided between the battery and the inverter, a smoothing capacitor that smoothes voltage between terminals of the inverter, a failure detector that detects a failure of the inverter, and a discharge control module that controls the buck-boost converter so that stored electric charge is discharged from the smoothing capacitor when the failure detector detects the failure of the inverter.

In the second vehicle according to the present invention, the buck-boost converter is controlled so that stored electric charge is discharged from the smoothing capacitor that smoothes voltage between terminals of the inverter upon a detection of the failure of the inverter. Thus, the stored electric charge can be securely discharged from the smoothing capacitor even when the failure of the inverter occurs.

In the second vehicle according to the present invention, the buck-boost converter may include a reactor having one connection terminal connected to a positive terminal of the battery, a first switching element that switches between connection and disconnection between the other connection terminal of the reactor and a positive terminal of the inverter, and a second switching element that switches between connection and disconnection between the other connection terminal of the reactor and negative terminals of the battery and the inverter. Further, the discharge control module may perform switching control of the first and second switching elements so that the stored electric charge is discharged from the smoothing capacitor. In this case, the discharge control module may control the first and second switching elements so that a positive terminal and a negative terminal of the smoothing capacitor are short-circuited. Thus, the stored electric charge can be immediately discharged from the smoothing capacitor.

In the second vehicle according to the present invention, the discharge control module may control the inverter so that the stored electric charge is discharged from the smoothing capacitor when the stored electric charge is to be discharged from the smoothing capacitor and the failure detector does not detect the failure of the inverter.

A first method according to the present invention is a discharge method of a smoothing capacitor in a vehicle that includes a synchronous motor generator that inputs and outputs power for driving the vehicle, an inverter that drives the synchronous motor generator, a battery, and a buck-boost converter provided between the battery and the inverter, the smoothing capacitor smoothing voltage between terminals of the inverter. The method includes controlling the buck-boost converter so that stored electric charge is discharged from the smoothing capacitor upon a collision of the vehicle.

In the first method according to the present invention, the buck-boost converter is controlled so that stored electric charge is discharged from the smoothing capacitor that smoothes voltage between terminals of the inverter upon a detection of the collision of the vehicle. Thus, the stored electric charge can be securely discharged from the smoothing capacitor even when the synchronous motor generator and/or the inverter fail upon an occurrence of the collision of the vehicle.

A second method according to the present invention is a discharge method of a smoothing capacitor in a vehicle that includes a synchronous motor generator that inputs and outputs power for driving the vehicle, an inverter that drives the synchronous motor generator, a battery, and a buck-boost converter provided between the battery and the inverter, the smoothing capacitor smoothing voltage between terminals of the inverter. The method includes controlling the buck-boost converter so that stored electric charge is discharged from the smoothing capacitor upon a failure of the inverter.

In the second method according to the present invention, the buck-boost converter is controlled so that stored electric charge is discharged from the smoothing capacitor that smoothes voltage between terminals of the inverter upon a detection of the failure of the inverter. Thus, the stored electric charge can be securely discharged from the smoothing capacitor even when the failure of the inverter occurs.

### BRIEF DESCRIPTION OF THE DRAWINGS

FIG. 1 is a schematic block diagram of an electric vehicle 10 of an embodiment according to the present invention; and

FIG. 2 is a flowchart exemplifying a discharge routine executed by an electronic control unit 50 of the embodiment.

### DESCRIPTION OF THE PREFERRED EMBODIMENTS

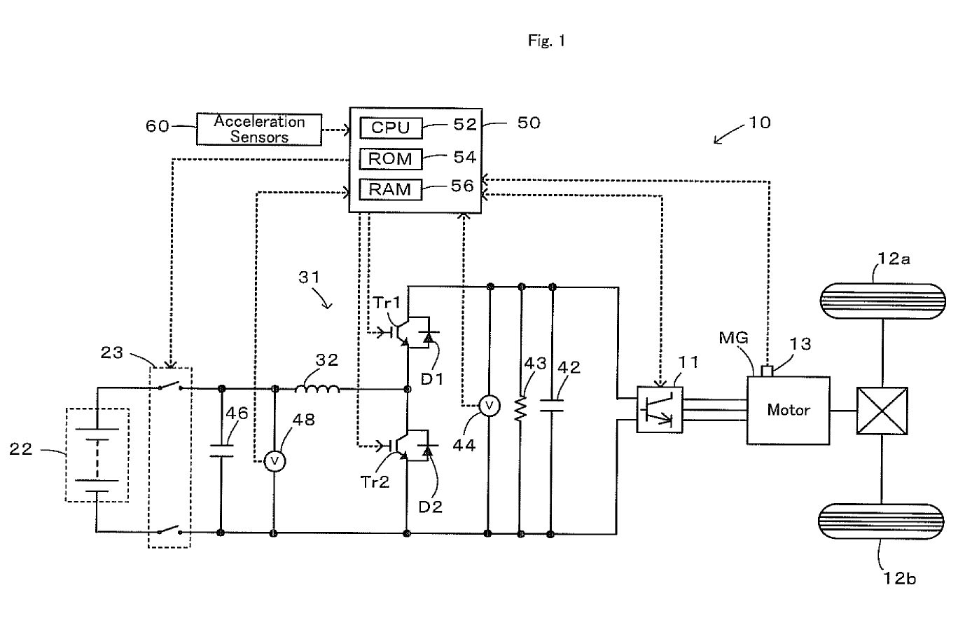

Hereinafter, the best mode for carrying out the invention will be described with reference to embodiments. FIG. 1 is a schematic block diagram of an electric vehicle 10 of an embodiment according to the present invention. As shown in FIG. 1, electric vehicle 10 includes driving wheels 12a and 12b, a motor MG that inputs and outputs power for driving the electric vehicle 10, an inverter 11 that drives the motor MG, a battery 22 or a DC power supply connected to the inverter 11 through a relay 23, a buck-boost converter 31 that boosts a voltage from the battery 22 and supplies the boosted voltage to the inverter 11 as well as lowers a voltage from the inverter 11 and supplies the lowered voltage to the battery 22, a smoothing capacitor 42 that is connected to a positive bus and a negative bus in parallel with the inverter 11 and the buck-boost converter 31 and smoothes the boosted voltage (hereafter referred to as “high voltage side voltage”) Vh, a resistance element 43 that is connected to the positive bus and the negative bus in parallel with the inverter 11 and the buck-boost converter 31 and is capable of discharging electric charge stored in the smoothing capacitor 42, a smoothing capacitor 46 that is connected to the positive bus and the negative bus in parallel with the battery 22 and smoothes a non-boosted voltage (hereafter referred to as “low voltage side voltage”) V1, and an electronic control unit 50 that controls the whole vehicle.

The motor MG is constructed as a known synchronous motor generator to enable operations as both a generator and a motor. The motor MG receives and supplies electric power to the battery 22 via the inverter 11 and the buck-boost converter 31.

The inverter 11 is constructed as a known inverter capable of driving and rotating the motor MG. The inverter supplies phase currents to three phase (U phase, V phase and W phase) coils of the motor MG to form a rotating magnetic field by switching control of a plurality of gate type switching elements (for example, Insulated Gate Bipolar Transistor).

The battery 22 is constructed as a chargeable and dischargeable secondary cell such as a lithium ion secondary battery or nickel hydrogen secondary battery.

The buck-boost converter 31 is constructed as a known buck-boost converter. The buck-boost converter 31 includes two gate type switching elements (for example, Insulated Gate Bipolar Transistor) Tr1, Tr2 in series that are connected to the positive bus and the negative bus in parallel with the smoothing capacitor 42, two diodes D1, D2 that are connected in parallel with the switching elements Tr1 or Tr2 and respectively holds a voltage, and a coil 32 that is connected to a midpoint between the two switching elements Tr1 and Tr2 and a positive terminal of the battery 22.

The electronic control unit 50 is constructed as a microprocessor including a CPU 52, a ROM 54 configured to store processing programs, a RAM 56 configured to temporarily store data, input and output ports (not shown), and a communication port (not shown). The electronic control unit 50 inputs, via its input port, a signal representing a rotational position of a rotor of the motor MG from a rotational position detection sensor 13, signals representing phase currents to be applied to the motor MG from current sensors (not shown) provided in the inverter 11, the high voltage side voltage Vh from a voltage sensor 44 connected to terminals of the smoothing capacitor 42, the low voltage side voltage V1 from a voltage sensor 48 that is connected to terminals of the smoothing capacitor 46, accelerations from acceleration sensors 60 that are disposed in both front sides of the vehicle 10 and the like. The electronic control unit 50 outputs, via its output port, switching signals to the inverter 11, switching signals to the switching elements Tr1, Tr2 of the buck-boost converter 31, a drive signal to the relay 23 and the like. The electronic control unit 50 of the embodiment performs a collision determination process (not shown) to determine whether a collision of the vehicle occurs or not by comparing accelerations from the acceleration sensors 60 with a corresponding threshold value equivalent to an acceleration generated upon an occurrence of the collision of the vehicle. The electronic control sensor 50 sets a collision determination flag Fc that is initially set to value “0” to value “1” when determining that the collision of the vehicle occurs and stores the value of the collision determination flag Fc in a predetermined a memory region of the RAM 56. Further, the electronic control unit 50 of the embodiment performs an inverter failure determination process (not shown) to determine whether a failure of the inverter 11 occurs or not by comparing phase currents applied to the motor MG with values different from currents normally passing through each phase (for example, excessively large current, excessively small current, or value “0”). The electronic control sensor 50 sets an inverter failure flag Finv that is initially set to value “0” to value “1” when determining that the failure of the inverter occurs and stores the value of the inverter failure flag Finv in a predetermined a memory region of the RAM 56.

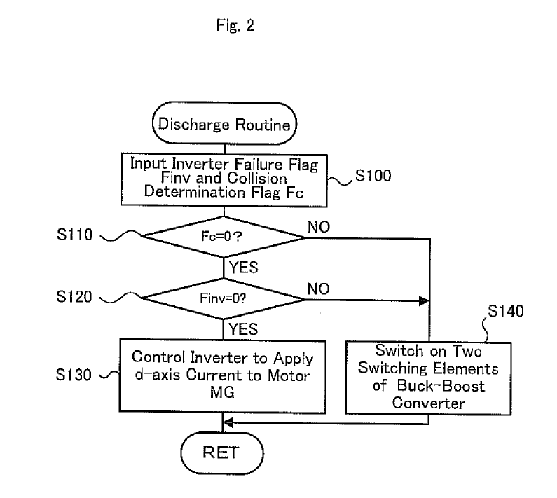

Next, an explanation will be given of an operation of the electric vehicle 10, in particular, of a discharge of stored electric charge from the smoothing capacity 42 in the high voltage side. FIG. 2 is a flowchart exemplifying a discharge routine executed by the electronic control unit 50 of the embodiment. The discharge routine is executed when the system is shut down, when the collision of the vehicle occurs, and when the system is to be shut down due to a system failure. When the discharge routine is executed, the battery 22 is cut off by the relay 23 in advance of or at the same time with the execution of the discharge routine.

At start of the discharge routine, the CPU 52 of the electronic control unit 50 inputs values of the inverter failure flag Finv and the collision determination flag Fc (Step S100). The values of the inverter failure flag Finv and the collision determination flag Fc are set through the above inverter failure determination process or the above collision determination process and read out from the predetermined memory regions of the RAM 56. Then, the electronic control unit 50 checks the values of the inverter failure flag Finv and the collision determination flag Fc (Step S110 and S120).

When the inverter failure flag Finv is value “0” and the collision determination flag Fc is also value “0”, the electronic control unit 50 determines that the failure of the inverter 11 does not occur and the discharge of the electric charge from the smoothing capacitor 42 is not caused by the collision of the vehicle. In this case, the electronic control unit 50 controls the inverter 11 so that the electric charge is discharged from the smoothing capacitor 42 by applying a d-axis current to the motor MG (Step S130), and terminates the discharge routine. That is, the d-axis current is applied to cause the motor MG to generate heat, thereby discharging the stored electric charge from the smoothing capacitor 42. At this time, torque is not output from the motor MG unless the motor MG rotates. A heating value is small enough to prevent overheating of the motor MG in view of the electric charge of the smoothing capacitor 42 and heat capacity of the motor MG.

On the other hand, when the inverter failure flag Finv is value “1”, or even when the collision determination flag Fc is value “0” and the collision determination flag Fc is value “1”, the electronic control unit 50 switches on both of two switching elements Tr1 and Tr2 of the buck-boost converter 31 so that the stored electric charge is discharged from the smoothing capacitor 42 (Step S140), and terminates the discharge routine. By switching on the two switching elements Tr1 and Tr2 of the buck-boost converter 31, a positive terminal and a negative terminal of the smoothing capacitor 42 are short-circuited, so that the stored electric charge is instantaneously discharged from the smoothing capacitor 42. When the collision of the vehicle occurs, the failure of the motor MG and/or the inverter 11 may occur. Further, it is desirable that the stored electric charge is instantaneously discharged from the smoothing capacitor 42 when the collision of the vehicle occurs. Accordingly, when the collision determination flag Fc is value “1”, the stored electric charge is instantaneously discharged from the smoothing capacitor 42 by switching on the two switching elements Tr1 and Tr2 of the buck-boost converter 31. When the inverter failure flag Finv is value “1” even when the collision determination flag Fc is value “0”, the inverter 11 may not be controlled so that the d-axis current is to be applied to the motor MG. Accordingly, when the collision determination flag Fc is value “0” and the inverter failure flag Finv is value “1” and, both of the two switching elements Tr1 and Tr2 of the buck-boost converter 31 are switched on so that the stored electric charge is discharged from the smoothing capacitor 42.

As has been described above, when the collision of the electric vehicle 10 of the embodiment occurs, both of the two switching element Tr1 and Tr2 are switched on so that the stored electric charge is discharged from the smoothing capacity 42. Thus, the stored electric charge can be securely discharged from the smoothing capacitor 42 when the motor MG and/or the inverter 11 actually fail, or when there is possibility that the motor MG and/or the inverter 11 fail. Further, the positive terminal and the negative terminal of the smoothing capacitor 42 are short-circuited by switching on the two switching elements Tr1 and Tr2 of the buck-boost converter 31, so that the stored electric charge can be instantaneously discharged from the smoothing capacitor 42. When the collision of the vehicle does not occur and the inverter 11 normally operates, the inverter 11 is controlled so that the d-axis current is to be applied to the motor MG, thereby discharging the stored electric charge from the smoothing capacitor 42. Thus, the stored electric charge can be securely discharged from the smoothing capacitor 42 without excessive heating of the inverter 11 and the switching elements Tr1 and Tr2.

In the electric vehicle 10 of the embodiment, upon the occurrence of the failure of the inverter 11, the stored electric charge is discharged from the smoothing capacitor 42 by switching on the two switching elements Tr1 and Tr2 of the buck-boost converter 31. Thus, the stored electric charge can be instantaneously and securely discharged from the smoothing capacitor 42 even when the failure of the inverter 11 occurs.

In the electric vehicle 10 of the embodiment, the discharge of the electric charge from the smoothing capacitor 42 is performed in consideration of the collision of the vehicle and the failure of the inverter 11. The discharge of the electric charge from the smoothing capacitor 42 may be performed only in consideration of the collision of the vehicle. Further, the discharge of the electric charge from the smoothing capacitor 42 may be performed only in consideration of the failure of the inverter 11. When performing the discharge only in consideration of the collision of the vehicle, the process of Step S120 may be omitted from the discharge routine of FIG. 2. When performing the discharge only in consideration of the failure of the inverter 11, the process of Step S110 may be omitted from the discharge routine of FIG. 2.

In the electric vehicle 10 of the embodiment, upon the occurrence of the collision of the vehicle and the failure of the inverter 11, the stored electric charge is discharged from the smoothing capacitor 42 by switching on the two switching elements Tr1 and Tr2 of the buck-boost converter 31. However, the stored electric charge may be discharged from the smoothing capacitor 42 by switching on and off the two switching elements Tr1 and Tr2 of the buck-boost converter 31.

In the electric vehicle 10 of the embodiment, the accelerations from the acceleration sensors 60 are compared with the corresponding threshold value equivalent to the acceleration generated upon the occurrence of the collision of the vehicle in order to determine whether the collision of the vehicle occurs or not. However, in a vehicle with impact sensors, detection values of the impact sensors may be compared with a corresponding threshold value equivalent to an impact generated upon the occurrence of the collision of the vehicle in order to determine whether the collision of the vehicle occurs or not. In a vehicle with air bags or a driver protection system, it may be possible to determine that the collision of the vehicle occurs when at least one of the air bags operates.

The vehicle according to the present invention may be constructed as a hybrid vehicle with an engine instead of the electric vehicle 10 that does not include the engine. Further, the method according to the present invention may be a discharge method of a smoothing capacitor of the hybrid vehicle.

The correlation between the principal elements of the embodiments and modification examples, and the principal elements of the invention described in the “Summary of the Invention” section will now be described. That is, in the first vehicle according to the present invention and the embodiment, the motor MG corresponds to “synchronous motor”, the inverter 11 corresponds to “inverter”, the battery 22 corresponds to “battery”, the buck-boost converter 31 corresponds to “buck-boost converter”, the smoothing capacitor 42 corresponds to the “smoothing capacitor”, the electronic control unit 50 executing the collision determination routine corresponds to “collision detector”, and the electronic control unit 50 executing the discharge routine of FIG. 2 corresponds to “discharge control module”. In the second vehicle according to the present invention and the embodiment, the motor MG corresponds to “synchronous motor”, the inverter 11 corresponds to “inverter”, the battery 22 corresponds to “battery”, the buck-boost converter 31 corresponds to “buck-boost converter”, the smoothing capacitor 42 corresponds to the “smoothing capacitor”, the electronic control unit 50 executing the inverter failure determination process corresponds to “failure detector”, and the electronic control unit 50 executing the discharge routine of FIG. 2 corresponds to “discharge control module”.

The “collision detector” in the first vehicle according to the present invention may be implemented by any configuration of detecting the collision of the vehicle. That is, the “collision detector” may be a detector comparing detection values of the impact sensors with the corresponding threshold value equivalent to the impact generated upon the occurrence of the collision of the vehicle in order to determine whether the collision of the vehicle occurs or not, or a detector determining that the collision of the vehicle occurs when at least one of the air bags operates. The “discharge control module” in the first vehicle according to the present invention may be implemented by any configuration of controlling the buck-boost converter so that stored electric charge is discharged from the smoothing capacitor when the collision of the vehicle is detected. That is, the “discharge control module” may be a module switching on and off the two switching elements Tr1 and Tr2 of the buck-boost converter 31 when the collision of the vehicle is detected so that the stored electric charge is discharged from the smoothing capacitor 42. The “failure detector” in the second vehicle according to the present invention may be implemented by any configuration of detecting the failure of the inverter. The “discharge control module” may be implemented by any configuration of controlling the buck-boost converter so that stored electric charge is discharged from the smoothing capacitor when the failure of the inverter is detected. That is, the “discharge control module” in the second vehicle according to the present invention may be a module switching on and off the two switching elements Tr1 and Tr2 of the buck-boost converter 31 when the failure of the inverter is detected so that the stored electric charge is discharged from the smoothing capacitor 42.

In any case, the correspondences between the main elements in the embodiment and the variant and the main elements in the invention described in “Summary of the Invention” do not limit the elements in the invention described in “Summary of the Invention” since the embodiment is an example for describing in detail the best mode for carrying out the invention described in “Summary of the Invention”. Specifically, the embodiment is merely a detailed example of the invention described in “Summary of the Invention”, and the invention described in “Summary of the Invention” should be construed on the basis of the description therein.

Hereinbefore, the embodiments of the present invention have been described with reference to drawings, however, the present invention is not limited to the above embodiments. It will be apparent that various modifications can be made to the present invention without departing from the spirit and scope of the present invention.

The present invention can be used in a manufacturing industry or the like of a vehicle.

The disclosure of Japanese Patent Application No. 2009-41191 filed on Feb. 24, 2009 including specification, drawings and claims is incorporated herein by reference in its entirety.

What is claimed is:

1. A vehicle comprising:
a synchronous motor generator that inputs and outputs power for driving the vehicle;
an inverter that drives the synchronous motor generator;
a battery;
a buck-boost converter provided between the battery and the inverter;
a smoothing capacitor that smoothes voltage between terminals of the inverter;
a collision detector that detects a collision of the vehicle; and
a discharge control module that controls the buck-boost converter so that stored electric charge is discharged from the smoothing capacitor when the collision detector detects the collision of the vehicle.

2. A vehicle according to claim 1, wherein the buck-boost converter includes a reactor having one connection terminal connected to a positive terminal of the battery, a first switching element that switches between connection and disconnection between the other connection terminal of the reactor and a positive terminal of the inverter, and a second switching element that switches between connection and disconnection between the other connection terminal of the reactor and negative terminals of the battery and the inverter, and wherein the discharge control module performs switching control of the first and second switching elements so that the stored electric charge is discharged from the smoothing capacitor.

3. A vehicle according to claim 2, wherein the discharge control module controls the first and second switching elements so that a positive terminal and a negative terminal of the smoothing capacitor are short-circuited.

4. A vehicle according to claim 1, wherein the discharge control module controls the inverter so that the stored electric charge is discharged from the smoothing capacitor when the stored electric charge is to be discharged from the smoothing capacitor and the collision detector does not detect the collision of the vehicle.

5. A vehicle according to claim 4, further comprising a failure detector that detects a failure of the inverter, wherein the discharge control module controls the buck-boost converter so that the stored electric charge is discharged from the smoothing capacitor when the stored electric charge is to be discharged from the smoothing capacitor and the failure detector detects the failure of the inverter even when the collision detector does not detect the collision of the vehicle.

6. A vehicle comprising:
a synchronous motor generator that inputs and outputs power for driving the vehicle;
an inverter that drives the synchronous motor generator;
a battery;
a buck-boost converter provided between the battery and the inverter;
a smoothing capacitor that smoothes voltage between terminals of the inverter;
a failure detector that detects a failure of the inverter; and
a discharge control module that controls the buck-boost converter so that stored electric charge is discharged from the smoothing capacitor when the failure detector detects the failure of the inverter.

7. A vehicle according to claim 6, wherein the buck-boost converter includes a reactor having one connection terminal connected to a positive terminal of the battery, a first switching element that switches between connection and disconnection between the other connection terminal of the reactor and a positive terminal of the inverter, and a second switching element that switches between connection and disconnection between the other connection terminal of the reactor and negative terminals of the battery and the inverter, and wherein the discharge control module performs switching control of the first and second switching elements so that the stored electric charge is discharged from the smoothing capacitor.

8. A vehicle according to claim 7, wherein the discharge control module controls the first and second switching elements so that a positive terminal and a negative terminal of the smoothing capacitor are short-circuited.

9. A vehicle according to claim 6, wherein the discharge control module controls the inverter so that the stored electric charge is discharged from the smoothing capacitor when the stored electric charge is to be discharged from the smoothing capacitor and the failure detector does not detect the failure of the inverter.

10. A discharge method of a smoothing capacitor in a vehicle that includes a synchronous motor generator that inputs and outputs power for driving the vehicle, an inverter that drives the synchronous motor generator, a battery, and a buck-boost converter provided between the battery and the inverter, the smoothing capacitor smoothing voltage between terminals of the inverter, the method comprising:
controlling the buck-boost converter so that stored electric charge is discharged from the smoothing capacitor upon a collision of the vehicle.

11. A discharge method of a smoothing capacitor in a vehicle that includes a synchronous motor generator that inputs and outputs power for driving the vehicle, an inverter that drives the synchronous motor generator, a battery, and a buck-boost converter provided between the battery and the inverter, the smoothing capacitor smoothing voltage between terminals of the inverter, the method comprising:
controlling the buck-boost converter so that stored electric charge is discharged from the smoothing capacitor upon a failure of the inverter.
